(19) United States
(12) Patent Application Publication
(10) Pub. No.: US 2025/0007208 A1
(43) Pub. Date: Jan. 2, 2025

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Takanori OSAWA, Osaka (JP); Keigo TAKAHASHI, Osaka (JP)

(21) Appl. No.: 18/711,037

(22) PCT Filed: Oct. 28, 2022
(86) PCT No.: PCT/JP2022/040447

§ 371 Date: May 16, 2024

(30) Foreign Application Priority Data
Nov. 24, 2021 (JP) 2021-190014

(51) Int. Cl. H01R 13/58

(52) U.S. Cl. CPC H01R 13/582

(57) ABSTRACT

A connector (10) includes a terminal module (30) including a terminal fitting (31) to be connected to a wire (33) and a housing (20) for accommodating the terminal module (30). The housing (20) includes a housing body (60) having an accommodation space (S1) for accommodating the terminal module (30), and a cover (70) for covering the accommodation space (S1), a routing space (S2) for routing the wire (33) being provided between the cover (70) and the housing body (60). The wire (33) routed in the routing space (S2) is drawn out from the housing (20). The housing body (60) and the cover (70) include a strain relief portion (80) for sandwiching the wire (33) in the routing space (S2) in a bent state.

### TECHNICAL FIELD

The present disclosure relates to a connector.

### BACKGROUND

An L-shaped connector disclosed in Patent Document 1 is provided with an inner housing and an L-shaped terminal to be connected to a shielded cable and accommodated in the inner housing. The shielded cable connected to the L-shaped terminal by crimping is drawn to outside from the lower end of the inner housing.

### PRIOR ART DOCUMENT

### Patent Document

Patent Document 1: JP 2011-119120 A

### SUMMARY OF THE INVENTION

### Problems to be Solved

In the connector of Patent Document 1, if the shielded cable is pulled downward, a pulling force is applied to a connected part of the shielded cable and the L-shaped terminal. Thus, the connected part of the shielded cable and the L-shaped terminal may be damaged and the shielded cable may be detached from the L-shaped terminal.

The present disclosure was completed on the basis of the above situation and aims to suppress the damage of a connected part of a wire and a terminal fitting.

### Means to Solve the Problem

The present disclosure is directed to a connector with a terminal module including a terminal fitting to be connected to a wire, and a housing for accommodating the terminal module, the housing including a housing body having an accommodation space for accommodating the terminal module and a cover for covering the accommodation space, a routing space for routing the wire being provided between the cover and the housing body, the wire routed in the routing space being drawn out from the housing, and the housing body and the cover being provided with a strain relief portion for sandwiching the wire in the routing space in a bent state.

### Effect of the Invention

According to the present disclosure, it is possible to suppress the damage of a connected part of a wire and a terminal fitting.

### BRIEF DESCRIPTION OF THE DRAWINGS

FIG. 1 is a perspective view showing an example of a connector according to one embodiment.

FIG. 2 is an exploded perspective view of FIG. 1.

FIG. 3 is a perspective view including a partial cross-section of a terminal module.

FIG. 4 is a section of the terminal module when viewed from right.

FIG. 5 is a perspective view of a housing body when viewed from behind.

FIG. 6 is a perspective view of the connector except a cover when viewed from behind.

FIG. 7 is a section of the connector connected to a mating connector when viewed from right.

FIG. 8 is a section cut at a position different from that in FIG. 7.

FIG. 9 is a diagram showing a state of inserting the terminal module into a routing space.

FIG. 10 is a diagram showing a state of inserting the terminal module into an accommodation space.

### DETAILED DESCRIPTION TO EXECUTE THE INVENTION

### [Description of Embodiments of Present Disclosure]

First, embodiments of the present disclosure are listed and described.

(1) The connector of the present disclosure is provided with a terminal module including a terminal fitting to be connected to a wire, and a housing for accommodating the terminal module, the housing including a housing body having an accommodation space for accommodating the terminal module and a cover for covering the accommodation space, a routing space for routing the wire being provided between the cover and the housing body, the wire routed in the routing space being drawn out from the housing, and the housing body and the cover being provided with a strain relief portion for sandwiching the wire in the routing space in a bent state.

According to the connector of the present disclosure, even if the wire drawn out from the housing is pulled, the application of a pulling force to a connected part of the wire and the terminal fitting can be suppressed. Therefore, the damage of the connected part of the wire and the terminal fitting can be suppressed.

(2) Preferably, the terminal module includes a plurality of the terminal fittings, a plurality of the wires are routed in parallel in the routing space, and the housing is provided with an expansion preventing wall for sandwiching the plurality of wires from outer sides in an array direction.

According to this configuration, if the wires on outer sides in the array direction expand outward, the expanding wires may not function as strain reliefs. However, by sandwiching the plurality of wires from the outer sides in the array direction, lengths of all the wires in the routing space can be aligned and all the wires can function as strain reliefs.

(3) Preferably, the housing body includes a first opening for allowing the terminal module to be inserted along a first insertion direction and a second opening for allowing the terminal module to be inserted into the accommodation space from a second insertion direction intersecting the first insertion direction, the expansion preventing wall is formed in the housing body, and the expansion preventing wall is provided with a guide surface for guiding the terminal module moving toward a front side in the first insertion direction toward a rear side in the second insertion direction.

According to this configuration, the terminal module inserted into the routing space via the first opening can be guided to the second opening (rear side in the second insertion direction) of the accommodation space by the guide surface provided on the expansion preventing wall. In this way, the terminal module is more smoothly inserted into the accommodation space.

(4) Preferably, the plurality of wires include a differential pair cable for communication, the differential pair cable is surrounded by one sheath, an end part of the sheath on the front side in the first insertion direction is located in a formation range of the guide surface in the first insertion direction, and the housing body is provided with a recess recessed from the guide surface at a position overlapping the guide surface in the first insertion direction.

According to this configuration, the expansion of the differential pair cable in the routing space can be prevented by the sheath. Moreover, by inserting the end part of the sheath on the front side in the first insertion direction into the recess provided at the position overlapping the guide surface, the interference of this end part with the guide surface and the like of the housing body can be prevented.

(5) Preferably, the strain relief portion includes a first bent path and a second bent path provided at a position closer to the accommodation space than the first bent path, and a clearance between the second bent path and the wire is smaller than a clearance between the first bent path and the wire.

According to this configuration, the rattling (vibration) of the wire can be more suppressed at a position (second bent path) near the accommodation space than at a position (first bent path) distant from the accommodation space in the routing space. In this way, a load on the connected part of the wire and the terminal fitting can be suppressed.

### [Details of Embodiment of Present Disclosure]

### Embodiment

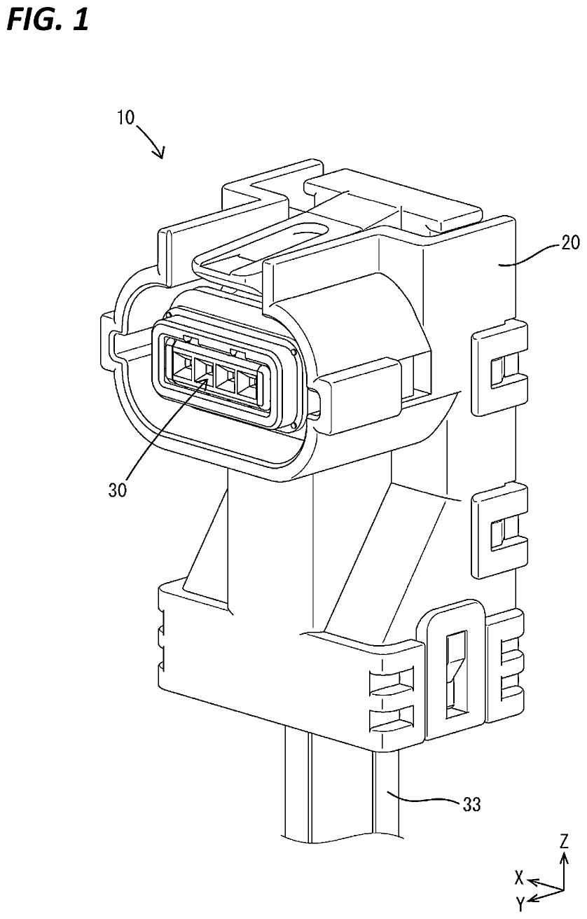

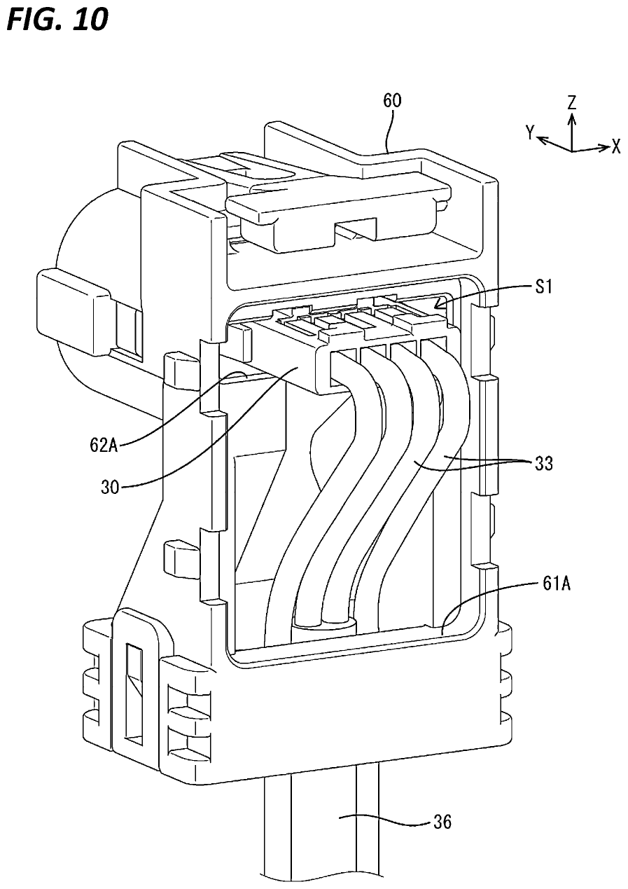

One specific embodiment of a connector of the present disclosure is described with reference to FIGS. 1 to 10. In this embodiment, a positive direction along a Z axis and a negative direction along the Z axis in FIGS. 1, 9 and 10 are defined as an upward direction and a downward direction concerning a vertical direction. A positive direction along a Y axis and a negative direction along the Y axis in FIGS. 1, 9 and 10 are defined as a forward direction and a rearward direction concerning a front-rear direction. A positive direction along an X axis and a negative direction along the X axis in FIGS. 1 and 10 are defined as a leftward direction and a rightward direction concerning a lateral direction.

### (Configuration of Connector)

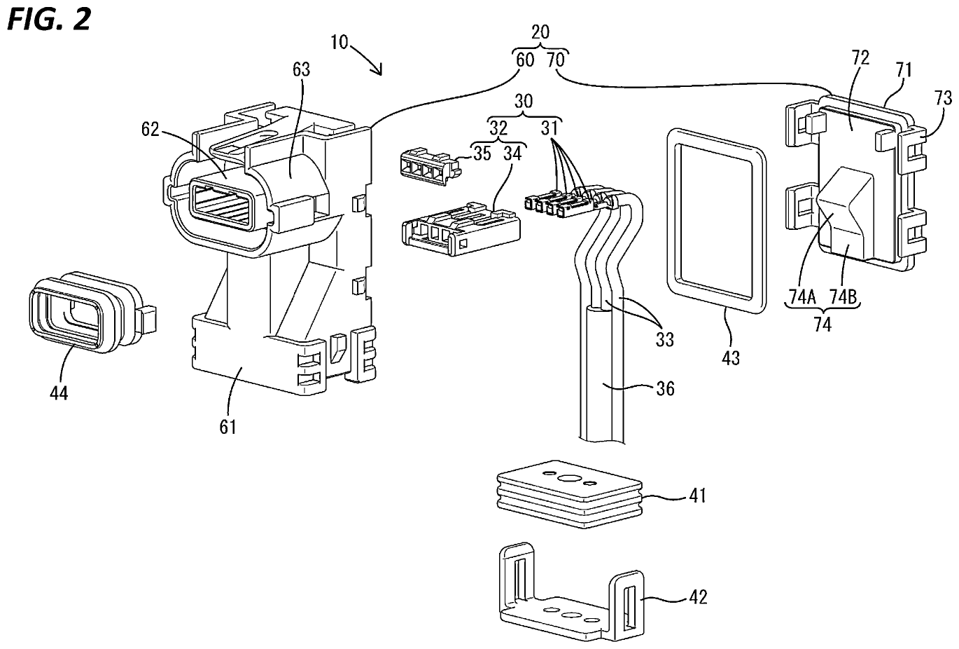

A connector 10 of this embodiment is, as shown in FIGS. 1 and 2, provided with a housing 20, a terminal module 30, a plug 41, a plug cover 42, a first sealing ring 43 and a second sealing ring 44. The connector 10 is configured as a female connector. The terminal module 30 is accommodated in the housing 20.

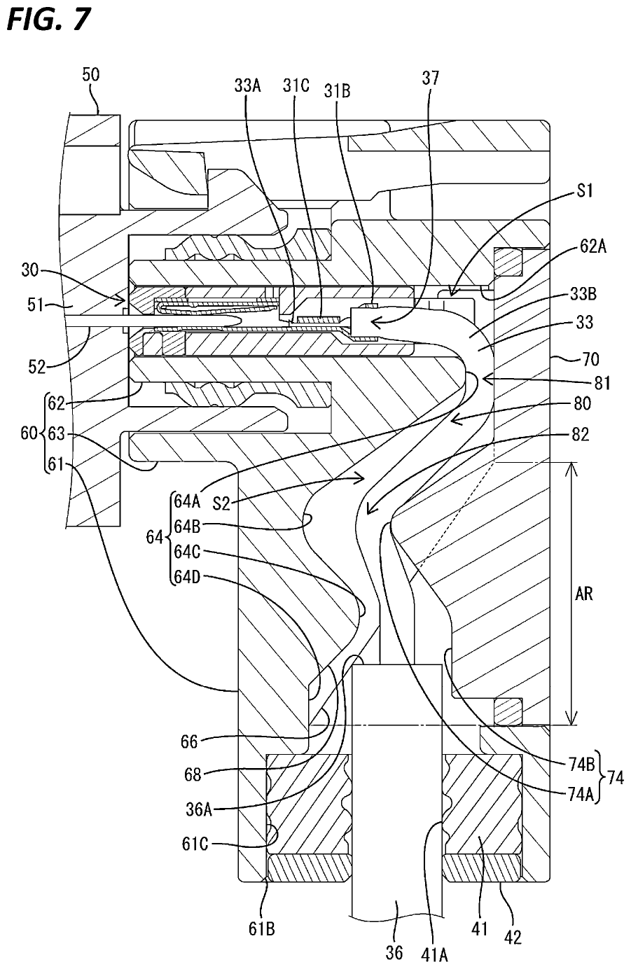

As shown in FIG. 7, the connector 10 is connected to a mating connector 50. The mating connector 50 is configured as a male connector. The mating connector 50 is provided with a mating housing 51 and mating terminal fittings 52. By connecting the housing 20 and the mating housing 51, terminal fittings 31 to be described later and the mating terminal fittings 52 are connected.

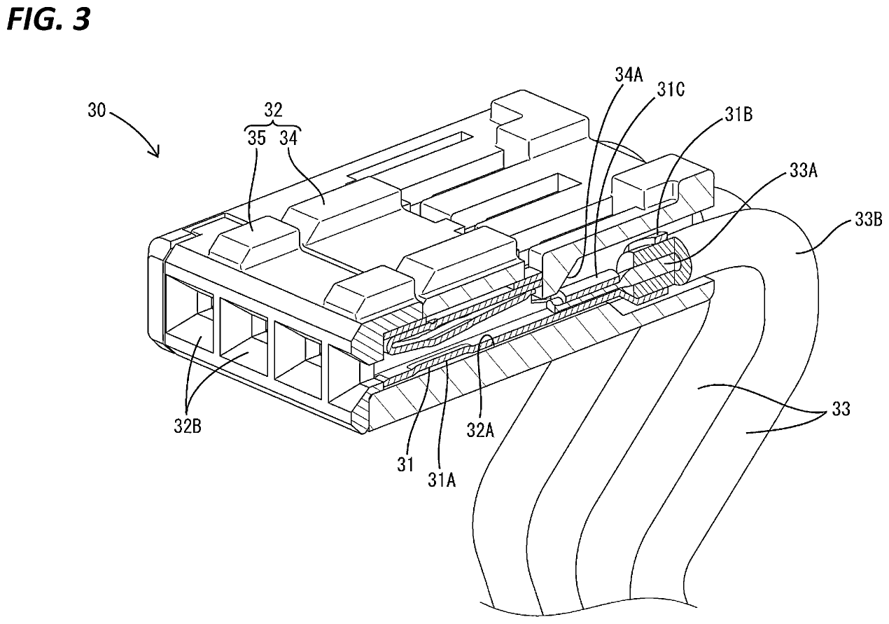

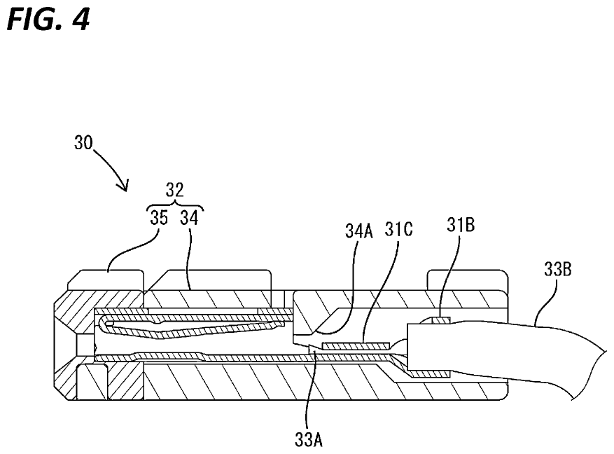

As shown in FIGS. 3 and 4, the terminal module 30 is provided with the terminal fittings 31 and a terminal accommodating member 32. The terminal module 30 is in the form of a block having a laterally long rectangular shape in a plan view. The terminal fitting 31 is connected to a wire 33. The wire 33 includes a conductor wire 33A and an insulation coating 33B covering the conductor wire 33A. The terminal fitting 31 includes a box portion 31A, a first crimping portion 31B and a second crimping portion 31C. The mating terminal fitting 52 is inserted into the box portion 31A. The first crimping portion 31B is crimped to the insulation coating 33B. The second crimping portion 31C is crimped to the conductor wire 33A drawn out from the insulation coating 33B of the wire 33.

As shown in FIGS. 3 and 4, the terminal accommodating member 32 includes a body portion 34 and a front portion 35. Each of the body portion 34 and the front portion 35 is a single component made of synthetic resin. By assembling the front portion 35 with the body portion 34 from above, the terminal accommodating member 32 is configured. The terminal accommodating member 32 accommodates a plurality of the terminal fittings 31 (four terminal fittings 31 in this embodiment) arranged in parallel in a row in the lateral direction (array direction). The terminal accommodating member 32 is provided with a plurality of terminal accommodation chambers 32A (four terminal accommodation chambers 32A in this embodiment). Openings 32B of the terminal accommodation chambers 32A are provided in the front end of the terminal accommodating member 32. The wires 33 respectively connected to the plurality of terminal fittings 31 are drawn out from the rear end of the terminal accommodating member 32. The body portion 34 is provided with locking lances 34A for retaining the terminal fittings 31.

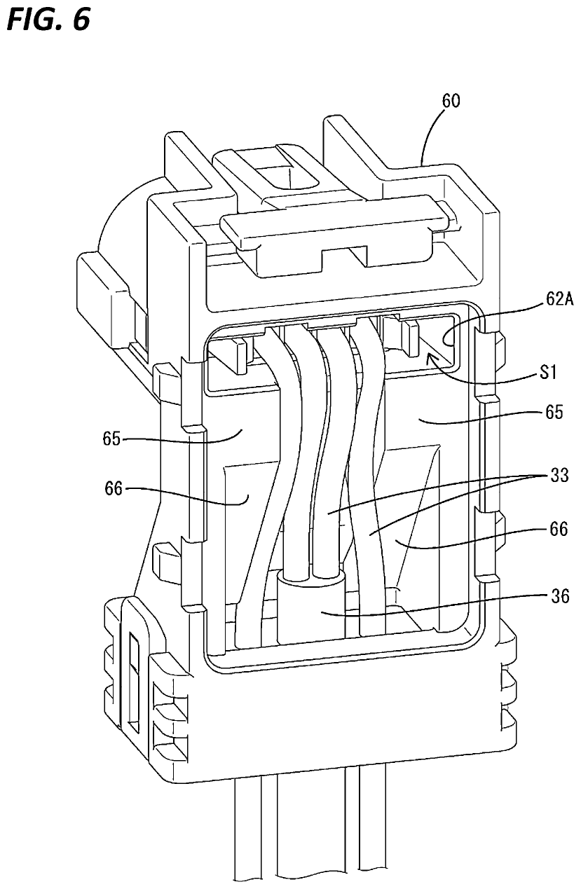

Two wires 33 connected to two terminal fittings 31 on an inner side in the lateral direction (array direction), out of the four terminal fittings 31, constitute a differential pair cable for communication. As shown in FIGS. 2 and 6, the two wires 33 constituting the differential pair cable are surrounded by one insulating sheath 36. The separation of the two wires 33 constituting the differential pair cable can be prevented and the degradation of communication performance can be prevented by the sheath 36. Two wires to be connected to two terminal fittings 31 on outer sides in the lateral direction (array direction) are, for example, power supply wires.

As shown in FIGS. 2 and 7, the housing 20 includes a housing body 60 and a cover 70. The housing 20 is L-shaped when viewed from the lateral direction. Each of the housing body 60 and the cover 70 is a single component made of synthetic resin. The housing 20 is configured by assembling the cover 70 with the housing body 60.

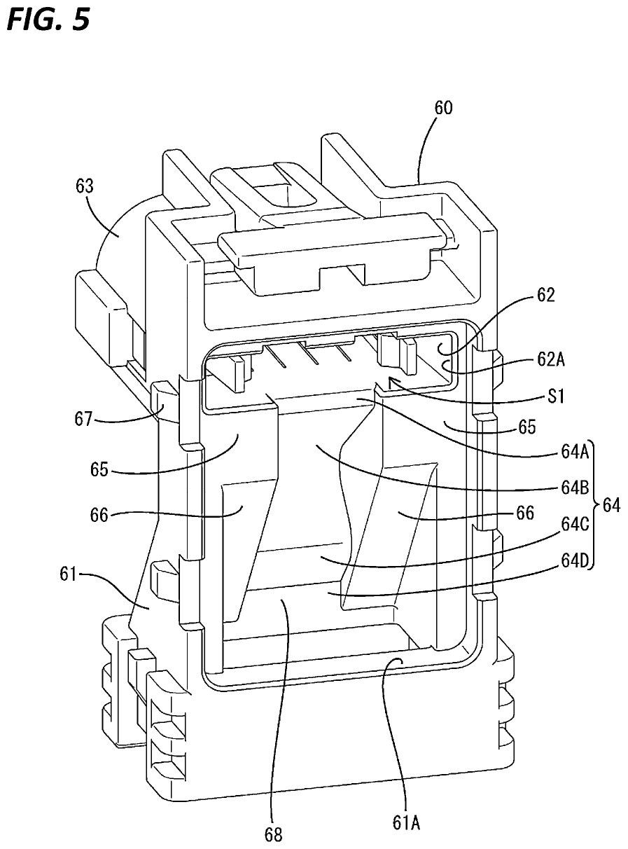

As shown in FIG. 5, the housing body 60 includes a routing-side body portion 61, an accommodation-side body portion 62 and a receptacle 63. The routing-side body portion 61 has a tube shape extending in the vertical direction. A rectangular body-side opening 61A is provided in the rear end of the routing-side body portion 61. A first opening 61B (see FIG. 7) penetrating in the vertical direction is provided in the lower end of the routing-side body portion 61. The accommodation-side body portion 62 projects forward from the upper end of the routing-side body portion 61. The receptacle 63 covers the outer periphery of the accommodation-side body portion 62. The second sealing ring 44 is disposed between the receptacle 63 and the accommodation-side body portion 62.

An accommodation space S1 for accommodating the terminal module 30 is provided in the accommodation-side body portion 62. The accommodation space S1 is a rectangular parallelepiped space long in the lateral direction. The front end of the accommodation space S1 communicates with outside to allow the insertion of the mating terminal fittings 52. A second opening 62A is provided at a rear end position of the accommodation space S1 in the accommodation-side body portion 62. The terminal module 30 is inserted from behind via the second opening 62A.

As shown in FIGS. 5 and 7, the routing-side body portion 61 is provided with a first routing portion 64. The first routing portion 64 has a wavy shape when viewed from the lateral direction. Arbitrary cross-sections of the first routing portion 64 orthogonal to the lateral direction have the same shape. The first routing portion 64 constitutes a lateral central part of the front wall in the routing-side body portion 61. A width in the lateral direction of the first routing portion 64 is nearly equal to a total of diameters of the four wires 33. The first routing portion 64 includes a first protrusion 64A, a first recess 64B, a second protrusion 64C and a first flat portion 64D. In the first routing portion 64, the first protrusion 64A, the first recess 64B, the second protrusion 64C and the first flat portion 64D are successively connected from an upper side. The first protrusion 64A has a chevron shape projecting rearward. The first protrusion 64A constitutes a rear end part of a lower wall constituting the accommodation space S1. The first recess 64B is recessed forward. The second protrusion 64C has a chevron shape projecting rearward. The tip of the second protrusion 64C is located forward of that of the first protrusion 64A. The first and second protrusions 64A, 64C have a tip in the form of a convex curved surface. The first flat portion 64D has a surface parallel to the vertical direction and lateral direction.

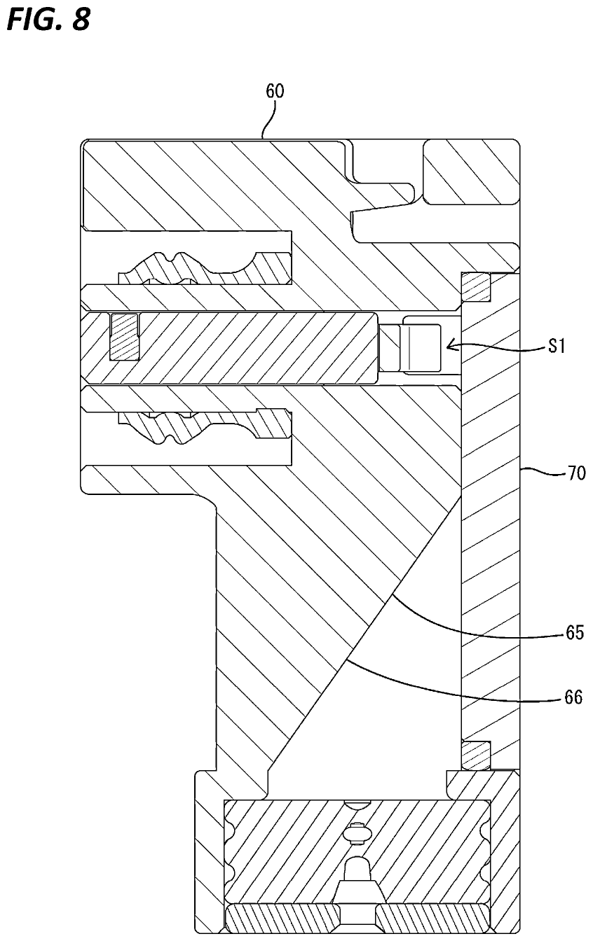

As shown in FIG. 5, the routing-side body portion 61 is provided with a pair of expansion preventing walls 65 for preventing the expansion of the plurality of wires 33. The expansion preventing walls 65 are provided adjacent to both sides in the lateral direction of the first routing portion 64 in the front wall in the routing-side body portion 61. By the pair of expansion preventing walls 65 and the first routing portion 64, a lateral center has a step structure recessed on a front side. As shown in FIGS. 5 and 8, a guide surface 66 for guiding the terminal module 30 is provided on a lower end side of the expansion preventing wall 65. The guide surface 66 is an inclined surface protruding rearward toward an upper side. The rear end of the guide surface 66 is at a position overlapping the rear end (second opening 62A) of the accommodation space S1 in the vertical direction.

As shown in FIG. 7, the lower end of the routing-side body portion 61 is provided with a plug accommodating portion 61C for accommodating the plug 41. The plug accommodating portion 61C is open to outside via the first opening 61B. The plug 41 configured as a rubber plug is press-fit into the plug accommodating portion 61C. The sheath 36 is passed through a through hole 41A provided in a center of the plug 41. The plug cover 42 closes the first opening 61B and retains the plug 41.

As shown in FIG. 5, the routing-side body portion 61 is provided with lock receiving portions 67 to be locked by locking claws 73 of the cover 70 to be described later.

As shown in FIG. 2, the cover 70 includes a plate portion 71, a bulging portion 72, the locking claws 73 and a second routing portion 74. The cover 70 covers the accommodation space S1 of the housing body 60 from behind. The plate portion 71 is in the form of a rectangular plate corresponding to the shape of the body-side opening 61A of the housing body 60. The plate portion 71 closes the body-side opening 61A. The bulging portion 72 bulges forward from a center of the front surface of the plate portion 71. The first sealing ring 43 is mounted on the outer periphery of the bulging portion 72. A pair of the locking claws 73 are provided on each of both left and right sides of the plate portion 71.

As shown in FIG. 2, the second routing portion 74 projects forward from a lower end side of a lateral center of the bulging portion 72. A width in the lateral direction of the second routing portion 74 is slightly smaller than that of the first routing portion 64. Arbitrary cross-sections of the second routing portion 74 orthogonal to the lateral direction have the same shape. The second routing portion 74 includes a third protrusion 74A and a second flat portion 74B. In the second routing portion 74, the third protrusion 74A and the second flat portion 74B are successively connected from an upper side. The third protrusion 74A has a chevron shape projecting forward. The third protrusion 74A has a tip in the form of a convex curved surface. The second flat portion 74B has a surface parallel to the vertical direction and lateral direction.

As shown in FIG. 7, a routing space S2 for routing the wires 33 is provided between the housing body 60 and the cover 70. More specifically, the routing space S2 is formed by the first routing portion 64, the second routing portion 74 and the pair of expansion preventing walls 65. The routing space S2 is formed at a position above and adjacent to the plug accommodating portion 61C. The wires 33 routed in the routing space S2 are drawn out downward from the housing 20 via the first opening 61B.

As shown in FIG. 7, the housing body 60 and the cover 70 are provided with a strain relief portion 80 for sandwiching all the wires 33 in the routing space S2 in a bent state. The strain relief portion 80 is configured by the first routing portion 64 and the second routing portion 74. The wires 33 in the routing space S2 are held in a wavily bent state when viewed from the lateral direction by being sandwiched in the front-rear direction by the first and second routing portions 64, 74. Specifically, the wires 33 drawn out rearward from the terminal module 30 are pushed toward the first protrusion 64A by the second routing portion 74, thereby being bent to be convex rearward along the first protrusion 64A and to be convex forward along the third protrusion 74A. In this way, loose movements of all the wires 33 in the routing space S2 are restricted. Since the wire 33 is caught by the first and second routing portions 64, 74 and not shifted downward even if the wire 33 drawn out from the housing 20 is pulled downward, the application of a pulling force to a connected part 37 of the wire 33 and the terminal fitting 31 can be suppressed. Therefore, the damage of the connected part 37 of the wire 33 and the terminal fitting 31 can be suppressed. The connected part 37 is constituted by the first crimping portion 31B, the second crimping portion 31C and parts of the conductor wire 33A crimped by these.

The four wires 33 are routed in parallel in the lateral direction in the routing space S2. The wires 33 in the routing space S2 are sandwiched from outer sides in the lateral direction (array direction) by the pair of expansion preventing walls 65. If the wires 33 on the outer sides in the lateral direction (array direction) expand outward, the expanding wires 33 have an extra length, and these expanding wires 33 come out from the routing space S2 and are no longer caught by the first and second routing portions 64, 74. Thus, the expanding wires 33 may not function as strain reliefs. However, the lengths of all the wires 33 in the routing space S2 can be aligned by sandwiching the plurality of wires 33 in the lateral direction (array direction) by the pair of expansion preventing walls 65, and all the wires 33 can function as strain reliefs.

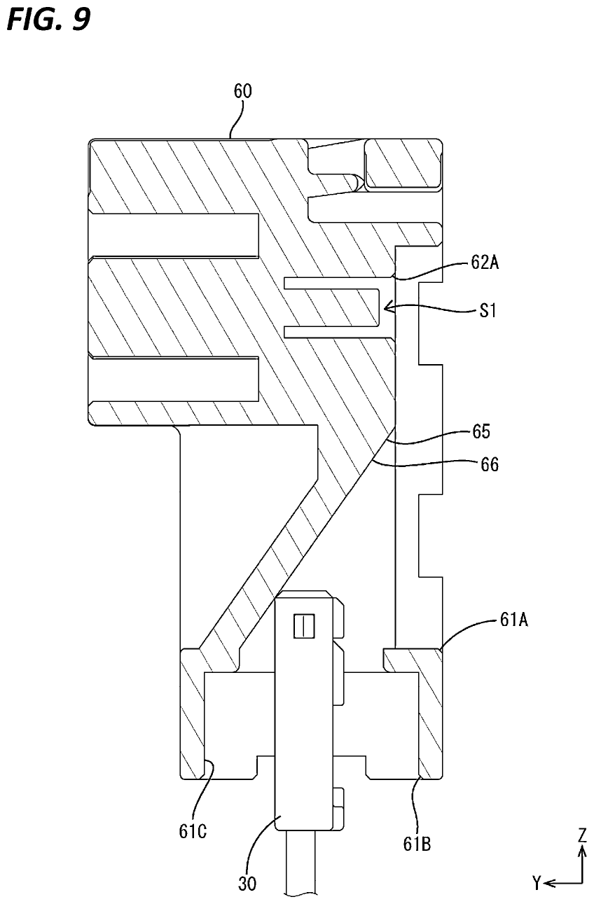

The terminal module 30 is assembled with the housing body 60 by a process shown in FIGS. 9 and 10. As shown in FIG. 9, the terminal module 30 is inserted into the housing body 60 via the first opening 61B and the plug accommodating portion 61C. As shown in FIG. 9, the terminal module 30 is inserted into the housing body 60 in such a posture that the array direction of the plurality of terminal fittings 31 is the lateral direction. A direction of inserting the terminal module 30 into the housing body 60 via the first opening 61B is defined as a first insertion direction. The first insertion direction is the vertical direction (Z-axis direction of FIG. 9). A front side in the first insertion direction is an upper side (positive direction side along the Z axis). A rear side in the first insertion direction is a lower side (negative direction side along the Z axis).

The terminal module 30 is inserted into the accommodation space S1 via the second opening 62A. A direction of inserting the terminal module 30 into the accommodation space S2 via the second opening 62A is defined as a second insertion direction. The second insertion direction is a direction intersecting the first insertion direction. The second insertion direction is a direction orthogonal to the first insertion direction, and is the front-rear direction (Y-axis direction of FIGS. 9 and 10). A front side in the second insertion direction is a front side (positive direction side along the Y axis). A rear side in the second insertion direction is a rear side (negative direction side along the Z axis).

A pair of left and right guide surfaces 66 guide the terminal module 30 moving toward the front side in the insertion direction (upper side) toward the rear side in the second insertion direction (rear side). Specifically, the terminal module 30 moving upward in the housing body 60 from the first opening 61B contacts the pair of left and right guide surfaces 66 from below. If moving further upward, the terminal module 30 is guided to a rear upper side by the guide surfaces 66. In this way, the terminal module 30 moves to behind the accommodation space S1 and the second opening 62A. Specifically, the terminal module 30 protrudes rearwardly of the housing body 60 via the body-side opening 61A. Thereafter, by inclining the terminal module 30 forward so that the tip of the terminal module 30 faces forward behind the second opening 62A, the terminal module 30 is more smoothly inserted into the accommodation space S1.

By providing the strain relief portion 80 inside the housing 20, extra lengths of the wires 33 necessary to accommodate the terminal module 30 into the accommodation space S1 are more easily created. Specifically, when the terminal module 30 is set in an insertion posture (posture shown in FIG. 2) into the accommodation space S1 behind the accommodation space S1, the extra lengths of the wires 33 are necessary to project rearward from the housing body 60. Since the wires 33 are bent by the strain relief portion 80, routing lengths of the wires 33 are set to be long as compared to a configuration in which the wires 33 are linearly routed. Thus, the extra lengths of the wires 33 necessary to accommodate the terminal module 30 into the accommodation space S1 can be created, utilizing the wires 33 in routed parts set to be long.

As shown in FIG. 7, an end part (upper end) 36A of the sheath 36 on the front side in the first insertion direction is located in a formation range AR of the guide surfaces 66 in the first insertion direction (vertical direction). The formation range AR is a range from the lower ends to the upper ends of the guide surfaces 66 in the vertical direction. The housing body 60 is provided with a recess 68 recessed further forward than the guide surfaces 66 at a position overlapping the guide surfaces 66 in the first insertion direction. The recess 68 is constituted by lower end parts of the pair of expansion preventing walls 65 and a lower end part of the first routing portion 64 (lower end part of the second protrusion 64C, upper end part of the first flat portion 64D). The end part 36A of the sheath 36 can enter the recess 68. Thus, the interference of the end part 36A of the sheath 36 with the guide surfaces 66 and the like of the housing body 60 can be prevented.

As shown in FIG. 7, the strain relief portion 80 includes a first bent path 81 and a second bent path 82. The first bent path 81 is a path for bending and holding the wires 33 on a lower end side of the routing space S2. The second bent path 82 is a path for bending and holding the wires 33 on an upper end side of the routing space S2. The second bent path 82 is provided at a position closer to the accommodation space S1 than the first bent path 81. The first bent path 81 includes the first recess 64B and the third protrusion 74A. The second bent path 82 includes the first protrusion 64A and a part of the bulging portion 72 (part facing the first protrusion 64A in the front-rear direction).

A clearance between the second bent path 82 and the wires 33 is smaller than a clearance between the first bent path 81 and the wires 33. For example, the clearance between the first bent path 81 and the wires 33 is a gap formed between the first bent path 81 and the wires 33 in the front-rear direction. The clearance between the second bent path 82 and the wires 33 is a gap formed between the second bent path 82 and the wires 33 in the front-rear direction. For example, as shown in FIG. 7, the clearance between the second bent path 82 and the wires 33 is substantially not formed and is smaller than the clearance between the first bent path 81 and the wires 33. In this way, the rattling (vibration) of the wires 33 in the front-rear direction is more easily suppressed in the first bent path 81 than in the second bent path 82. Thus, a load on the connected parts 37 of the wires 33 and the terminal fittings 31 can be suppressed.

### (Effects of Embodiment)

In the connector 10 of this embodiment, the housing body 60 is provided with the strain relief portion 80 for sandwiching the wires 33 in the routing space S2 in the bent state. In this way, even if the wire 33 drawn out from the housing 20 is pulled, the application of a pulling force to the connected part 37 of the wire 33 and the terminal fitting 31 can be suppressed. Therefore, the damage of the connected part 37 of the wire 33 and the terminal fitting 31 can be suppressed.

Further, the connector 10 is provided with the expansion preventing walls 65 for sandwiching the plurality of wires 33 from the outer sides in the array direction. The expanding wires may not function as strain reliefs if the wires 33 on the outer sides in the array direction expand outward. However, according to the above configuration, the lengths of all the wires 33 in the routing space S2 can be aligned by sandwiching the plurality of wires 33 from the outer sides in the array direction and all the wires 33 can function as strain reliefs.

Further, the expansion preventing walls 65 are provided with the guide surfaces 66 for guiding the terminal module 30 moving toward the front side in the first insertion direction to the rear side in the second insertion direction. According to this, the terminal module 30 inserted into the routing space S2 via the first opening 61B can be guided to the second opening 62A (rear side in the second insertion direction) of the accommodation space S1 by the guide surfaces 66 provided on the expansion preventing walls 65. In this way, the terminal module 30 is more smoothly inserted into the accommodation space S1.

Further, the plurality of wires are surrounded by one sheath 36. The housing body 60 is provided with the recess 68 recessed from the guide surfaces 66 at the position overlapping the guide surfaces 66 in the first insertion direction. According to this, the expansion of the differential pair cable in the routing space S2 can be prevented by the sheath 36. Moreover, the end part 36A of the sheath 36 on the front side in the first insertion direction is inserted into the recess 68 provided at the position overlapping the guide surfaces 66, whereby the interference of this end part 36A with the guide surfaces 66 and the like of the housing body 60 can be prevented.

Further, the clearance between the second bent path 82 and the wires 33 is smaller than the clearance between the first bent path 81 and the wires 33. According to this, the rattling (vibration) of the wires 33 can be more suppressed at a position (second bent path 82) near the accommodation space S1 than at a position (first bent path 81) distant from the accommodation space S1 in the routing space S2. In this way, a load on the connected parts 37 of the wires 33 and the terminal fittings 31 can be suppressed.

### OTHER EMBODIMENTS

The present invention is not limited to the above described and illustrated embodiment, but is represented by claims. The present invention is intended to include all changes in the scope of claims and in the meaning and scope of equivalents and also include the following embodiments.

Although four terminal fittings 31 are provided in the connector 10 in the above embodiment, another number of terminal fittings 31 may be provided.

Although the housing 20 is provided with the pair of expansion preventing walls 65 in the above embodiment, the expansion preventing wall 65 may be provided only on either one of the left and right sides.

Although the two wires 33 on the inner side in the lateral direction, out of the plurality of wires 33, are constituted as the differential pair cable for communication in the above embodiment, these wires may be wires for another application.

Although the clearance between the second bent path 82 and the wires 33 is smaller than the clearance between the first bent path 81 and the wires 33 in the above embodiment, the clearance between the second bent path 82 and the wires 33 may be larger than or nearly equal to the other clearance.

### LIST OF REFERENCE NUMERALS

10 . . . connector
20 . . . housing
30 . . . terminal module
31 . . . terminal fitting
31A . . . box portion
31B . . . first crimping portion
31C . . . second crimping portion
32 . . . terminal accommodating member
32A . . . terminal accommodation chamber
32B . . . opening
33 . . . wire
33A . . . conductor wire
33B . . . insulation coating
34 . . . body portion
34A . . . locking lance
35 . . . front portion
36 . . . sheath
36A . . . end part
37 . . . connected part
41 . . . plug
41A . . . through hole
42 . . . plug cover
43 . . . first sealing ring
44 . . . second sealing ring
50 . . . mating connector
51 . . . mating housing
52 . . . mating terminal fitting
60 . . . housing body
61 . . . routing-side body portion
61A . . . body-side opening
61B . . . first opening
61C . . . plug accommodating portion
62 . . . accommodation-side body portion
62A . . . second opening
63 . . . receptacle
64 . . . first routing portion
64A . . . first protrusion
64B . . . first recess
64C . . . second protrusion
64D . . . first flat portion
65 . . . expansion preventing wall
66 . . . guide surface
67 . . . lock receiving portion
68 . . . recess
70 . . . cover
71 . . . plate portion
72 . . . bulging portion
73 . . . locking claw
74 . . . second routing portion
74A . . . third protrusion
74B . . . second flat portion
80 . . . strain relief portion
81 . . . first bent path
82 . . . second bent path
AR formation range
S1 . . . accommodation space
S2 routing space

1. A connector, comprising:
a terminal module including a terminal fitting to be connected to a wire; and
a housing for accommodating the terminal module,
the housing including:
a housing body having an accommodation space for accommodating the terminal module; and
a cover for covering the accommodation space, a routing space for routing the wire being provided between the cover and the housing body,
the wire routed in the routing space being drawn out from the housing, and
the housing body and the cover being provided with a strain relief portion for sandwiching the wire in the routing space in a bent state.

2. The connector of claim 1, wherein:
the terminal module includes a plurality of the terminal fittings,
a plurality of the wires are routed in parallel in the routing space, and
the housing is provided with an expansion preventing wall for sandwiching the plurality of wires from outer sides in an array direction.

3. The connector of claim 2, wherein:
the housing body includes:
a first opening for allowing the terminal module to be inserted along a first insertion direction; and
a second opening for allowing the terminal module to be inserted into the accommodation space from a second insertion direction intersecting the first insertion direction,
the expansion preventing wall is formed in the housing body, and
the expansion preventing wall is provided with a guide surface for guiding the terminal module moving toward a front side in the first insertion direction toward a rear side in the second insertion direction.

4. The connector of claim 3, wherein:
the plurality of wires include a differential pair cable for communication,
the differential pair cable is surrounded by one sheath,
an end part of the sheath on the front side in the first insertion direction is located in a formation range of the guide surface in the first insertion direction, and
the housing body is provided with a recess recessed from the guide surface at a position overlapping the guide surface in the first insertion direction.

5. The connector of claim 1, wherein:
the strain relief portion includes:
a first bent path; and
a second bent path provided at a position closer to the accommodation space than the first bent path, and
a clearance between the second bent path and the wire is smaller than a clearance between the first bent path and the wire.
